(19) United States
(12) Patent Application Publication
(10) Pub. No.: US 2003/0028806 A1
(43) Pub. Date: Feb. 6, 2003

(54) Dynamic allocation of ports at firewall

(76) Inventors: Rangaprasad Govindarajan, Plano, TX (US); Jogen Pathak, Dallas, TX (US)

Correspondence Address: R. Scott Rhoades, Strasburger & Price, LLP, 901 Main Street, Suite 4300, Dallas, TX, 75202-3794, US

(21) Appl. No.: 09/929,717

(22) Filed: Aug. 13, 2001

Related U.S. Application Data
(60) Provisional application No. 60/310,258, filed on Aug. 6, 2001.

(51) Int. Cl. H04L 9/00

(52) U.S. Cl. 713/201

(57) ABSTRACT

A system, apparatus, and method for dynamically allocating ports in a firewall is presented herein. During establishment of a data transfer session, such as a voice over IP call, the firewall receives signals which establish the data transfer session. The foregoing signals indicate the identity of the terminals as well as the port numbers used by the terminals. The firewall records the foregoing information. During the data transfer session, data packets for a terminal in the network of the firewall are examined for addresses and port numbers of the sender and destination. Wherein the foregoing information matches the information recorded during establishment of the data transfer session, the data packets are permitted to reach the terminal. Additionally, at the termination of the data transfer session, the record of the data transfer session is deleted, or otherwise indicated as invalid, and additional data packets received for the terminal are prevented from reaching the terminal, notwithstanding inclusion of the previously stored port numbers.

### PRIORITY DATA

This application claims the priority benefit of U.S. Provisional Application for Patent, Ser. No. ______, Attorney Docket No. 24148115.10, “Dynamic Allocation of Ports at Firewall”, filed Aug. 6, 2001, by Rangaprasad Govindarajan, and Jogen Pathak, which is hereby incorporated by reference for all purposes.

### FIELD

The present application relates to packet data networks, and more particularly, to security within packet data networks.

### BACKGROUND

Recent attacks by hackers and computer viruses have underscored the importance of security in computer networks. A commonly used network security measure is the use of a firewall. The firewall is placed at the point(s) of outside access of private networks, and acts as a gatekeeper through which all data transmissions from the outside of the private network must pass. Accordingly, security breaches from outside the private network are prevented from entering and damaging the private network.

The firewall filters data packet transmissions to terminals in the private network by examining the address and port numbers for the incoming data packets. Based on the port number, a firewall can determine the application associated with the data packet. The provisioning of port numbers to various applications is based on de facto standards. For example, port number 80 is universally known to be dedicated to world wide web applications.

The firewall filters data packets by permitting data packets addressed to a predetermined set of known and defined port numbers to reach terminals of the private network. Data packets that are transmitted to other ports are blocked by the firewall.

However, certain internet applications are not universally associated with a port number. For example, voice over packet network (voice over IP) telephony dynamically designates the ports for conducting a voice over IP call. Therefore, when data packets associated with a voice over IP call are received at the firewall, the port number identified in the data packet will not necessarily correspond to the predetermined set of port numbers, and the firewall will discard the data packet.

One possible solution is for the firewall to designate a range of ports for voice over IP telephony. However, as the range is increased, the possibility of usage of the port for unauthorized communications increases, thereby compromising the security of the private network.

Accordingly, it would be beneficial if the firewall could dynamically designate ports for conducting data transfer sessions.

### SUMMARY

Presented herein is a system, apparatus, and method for dynamically allocating port numbers to terminals in a private network. During establishment of a data transfer session, such as a voice over IP call, the firewall receives signals which establish the data transfer session. The foregoing signals indicate the identity of the terminals as well as the port numbers used by the terminals. The firewall records the foregoing information. During the data transfer session, data packets for a terminal in the network of the firewall are examined for addresses and port numbers of the sender and destination. Wherein the foregoing information matches the information recorded during establishment of the data transfer session, the data packets are permitted to reach the terminal. Additionally, at the termination of the data transfer session, the record of the data transfer session is deleted, or otherwise indicated as invalid, and additional data packets received for the terminal are prevented from reaching the terminal, notwithstanding inclusion of the previously stored port numbers.

### BRIEF DESCRIPTION OF THE DRAWINGS

FIG. 1 is a block diagram of an exemplary communication network;

FIG. 2 is a signal flow diagram describing the operation of an exemplary communication network;

FIG. 3 is a block diagram of an exemplary GSM communication network configured to provide packet data service in accordance with GPRS specifications;

FIG. 4A is a signal flow diagram describing the establishment of a voice over IP call originating from a terminal;

FIG. 4B is a signal flow diagram describing the establishment of voice over IP call to a terminal;

FIG. 5 is a signal flow diagram describing the transfer of voice over IP call data packets;

FIG. 6 is a block diagram of an exemplary firewall.

### DETAILED DESCRIPTION OF THE DRAWINGS

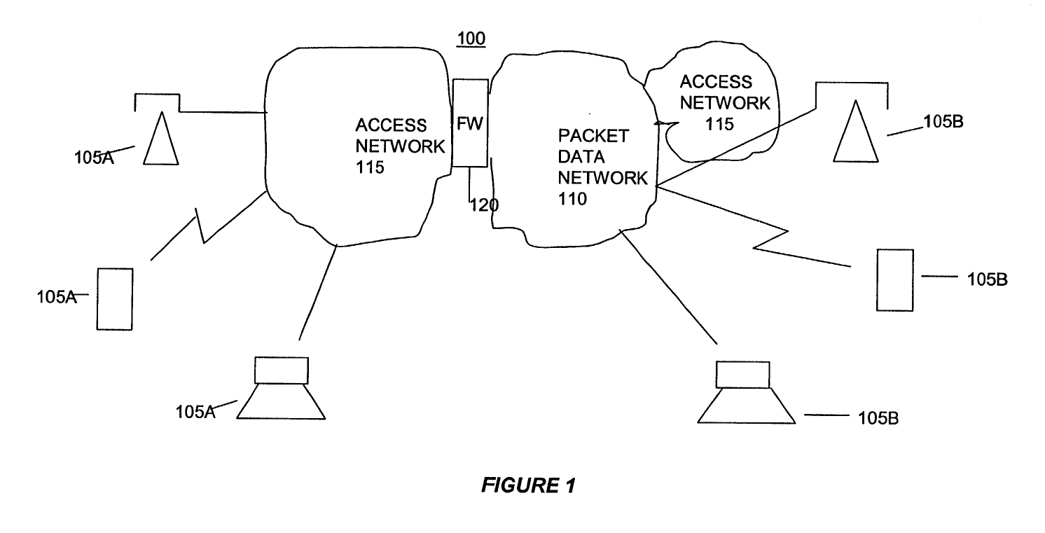

Referring now to FIG. 1, there is illustrated a block diagram of an exemplary communications network 100 for permitting a data transfer session between a first terminal 105a and a second terminal 105b. The data transfer session is a session wherein data packets are transferred between the terminals 105a and 105b. The terminals, 105a, 105b comprise the user interface to the communication network and can include, for example, a packet data telephone, a computer system, mobile station, or a personal digital assistant.

The communication network includes a packet data network 110, such as the internet, which routes the data from terminal 105a to terminal 105b and vice versa. Terminal 105a accesses the packet data network 110 by means of an access network 115. The access network 115 is a local network that is generally located in the proximity of the terminal 105a and can include, for example, a local area network, a wide area network, an intranet, or a wireless packet data services network.

The access network 115 or a portion thereof is interfaced with the packet data network 115 by means of a firewall 120. The firewall 120 acts as a gatekeeper for all data transmissions entering the access network 115. Viruses, as well as access by unauthorized users can be prevented by implementation of security software at the point of the firewall 120. Accordingly, security breaches in the packet data network 110, such as the propagation of a virus, can be prevented from damaging the access network 115 and the information therein.

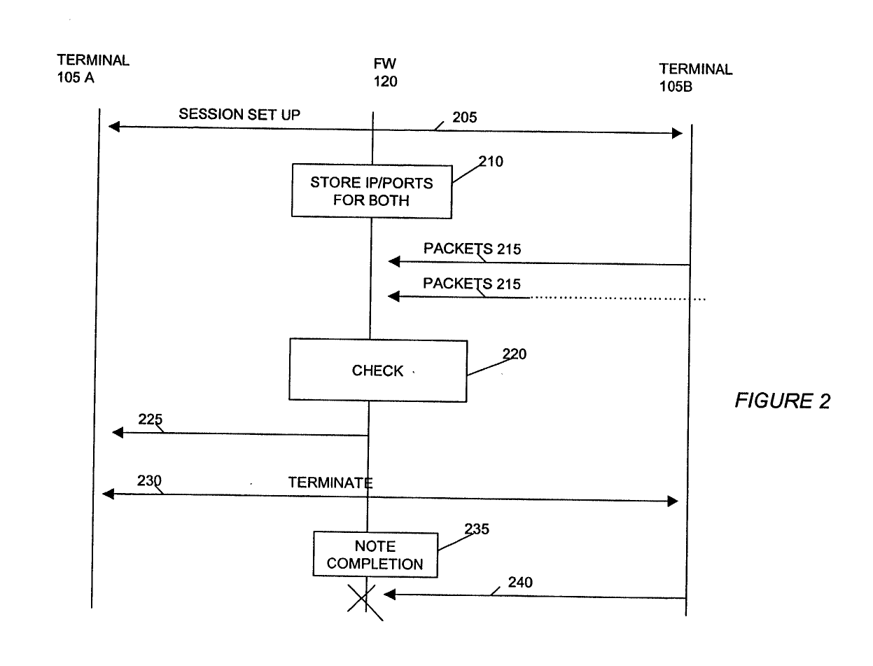

Referring now to FIG. 2, there is illustrated a signal flow diagram describing a data transfer session between terminal 105a and terminal 105b. The data transfer session is established by a session setup procedure (signal 205). During the session setup procedure, the terminals exchange the requisite information for the data transfer session, which includes, among other information, a packet data network address for each terminal 105, and a port number associated with the terminals 105 for the data transfer session. The port number can either be predetermined or dynamically designated by the terminals 105a, 105b.

The foregoing information is received and recorded at the firewall 120 (action 210). During the data transfer session, packet data is transmitted to the terminal 105a (signal 215). The firewall 120 examines the addresses and port numbers associated with the sender and the recipient for each of the received data packets (action 220). Wherein the addresses and port numbers associated with the sender and the recipient match the addresses and ports numbers stored for the data transfer session for terminal 105a, the firewall 120 permits the transmission of the data packets to terminal 105a (signal 225). However, wherein data packets addressed to terminal 105a, but to a different port number or from a different sender address, the data packet is prevented from transmission to terminal 105a.

At the completion of the data transfer session between terminals 105a and 105b, a terminate signal (signal 230) is transmitted therebetween. The terminate signal is received at firewall 120. Responsive to receiving the terminate signal, the firewall notes that the data transfer session is complete (action 235). After receipt of the terminate signal 230, any additional data packets (signal 240) received for terminal 105a which include the correct port numbers and sender address are prevented from transmission to terminal 105a.

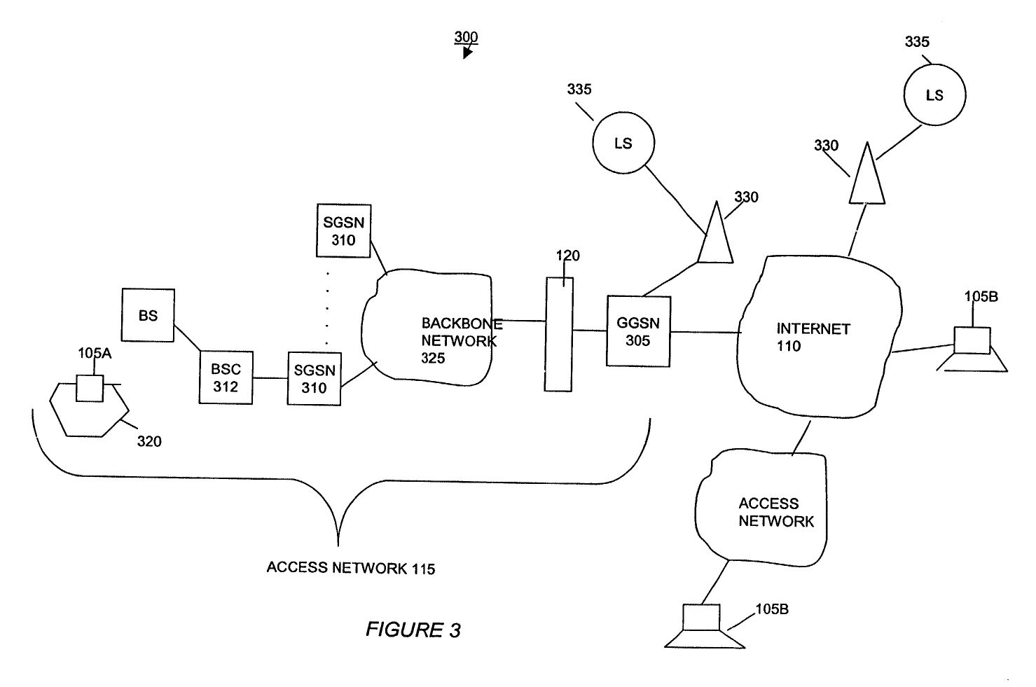

Referring now to FIG. 3, there is illustrated a block diagram of an exemplary communication network which supports General Packet Radio Services (GPRS). It is noted that certain elements are omitted for the purposes of simplicity and clarity. Therefore, the figure is not intended to be exhaustive. The access network 115 through which terminal 105a accesses the internet 110 comprises a wireless network. Pursuant to GSM and GPRS specifications, the wireless network is interfaced with the internet 110 by any number of Gateway GPRS Support Nodes (GGSN) 305. Each GGSN 305 is associated with any number of IP addresses which the GGSN 305, in turn, allocates to wireless clients 105.

The wireless network provides packet data services to geographical areas which are divided into routing areas. Each routing area is associated with a particular Serving GPRS Support Node (SGSN) 310. Each SGSN 310 is associated with any number of base station controllers 312. Each base station 312 controller is associated with and controls one or more base transceiver stations 315. The base transceiver station 315 is the radio transceiver equipment which transmits and receives signals to and from the terminal 105a. Base transceiver stations 315 maintain radio frequency communications within a geographic area known as a cell 320.

The SGSNs 310 and the GGSNs 305 are interconnected by a backbone network 325. The backbone network is a network which may form a portion of a wired network, such as the internet 110, and which routes packet data between the SGSNs 310 and the GGSNs 305. During transmission to the terminal 105a, the data packets are addressed to an IP address associated with the GGSN 305. The GGSN 305 receives the data packet, determines the identity and location of the terminal 105a associated with the IP address. After determining the location of the terminal 105a, the GGSN 305 determines the SGSN 310 associated with the cell containing the terminal 105a and forwards the packets to the terminal 105a via the backbone network 325, the SGSN 310, BSC 312, and base transceiver station 315.

The communication network 300 permits establishment of a particular type of data transfer session, known as a voice over internet protocol session (voice over IP call) between terminal 105a and terminal 105b using the Session Initiation Protocol (SIP). SIP is an application level protocol which can run on top of the Transmission Control Protocol (TCP). Pursuant to SIP, a calling terminal 105a initiates a voice over IP call by transmitting an INVITE signal to a call server 330. The INVITE signal includes the identity of the calling terminal 105a, a port number designated by the calling terminal 105a for the voice over IP call, and an identifier of the called terminal, e.g., terminal 105b.

The call server 330 is a server that can be operated by operators of the access network 115 and connected to the GGSN 305, or operated by another party and accessible over the internet 110. The call server 330 accesses a location server 335. The location server 335 includes a registry of any number of terminals 105b and location information for each of the terminals 105b. Responsive to a query from call server 330 for a particular identified terminal 105b, the location server 335 provides the location information associated with the identified terminal 105b.

Firewall 120 is placed in the wireless network. In one embodiment, the firewall 120 can be placed between the GGSN 305 and the backbone network 325 in a manner such that all communications between the GGSN 305 and terminal 105a are received at the firewall 120. In other embodiments, the firewall 1200 can be placed elsewhere in the wireless network or even integrated with a wireless network node. As noted above, the firewall 120 acts as a gatekeeper which examines and filters incoming data packets. Accordingly, security breaches, such as viruses and other unauthorized communications are prevented from entering the wireless network or a portion(s) thereof.

During a voice over IP call firewall 120 filters incoming data packets for terminal 105a by recording the identification and designated port number of both the calling terminal and the called terminal 105a, 105b which is received during the establishment of the voice over IP call. Data packets that are directed to terminal 105a are examined for the sending terminal, sending port, destination terminal, and destination port. Wherein the sending terminal, sending port, destination terminal, and destination port do not match the stored information, the data packets are prevented from reaching terminal 105a. Wherein the foregoing information matches the stored information, the data packets are permitted to reach terminal 105a. Additionally, at the termination of the voice over IP call, further data packets arriving after the termination are also prevented from reaching terminal 105a.

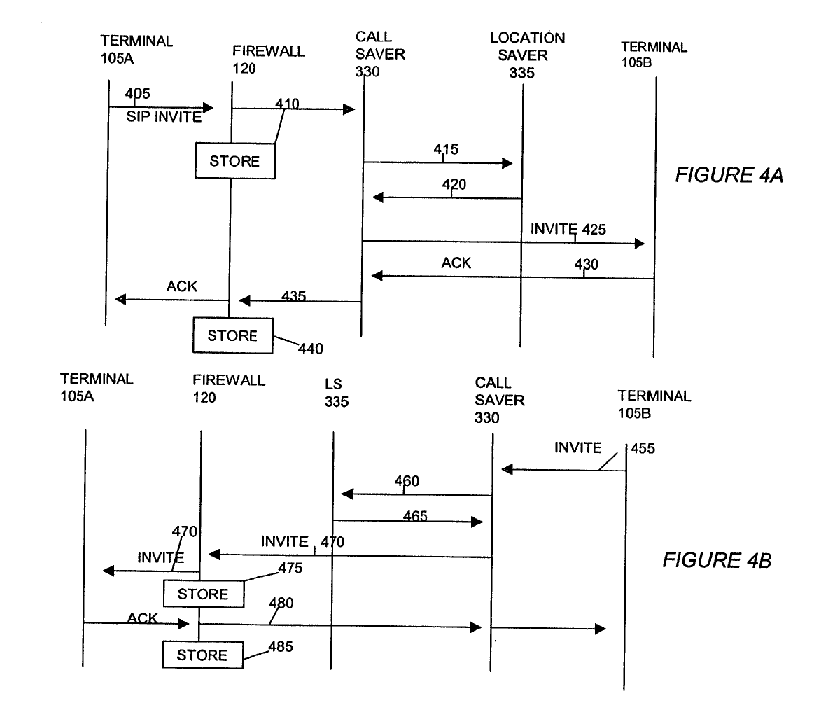

FIGS. 4A and 4B illustrate signal flow diagrams describing the establishment of a voice over IP calls. FIG. 4A describes the establishment of a voice over IP call from terminal 105a to terminal 105b. FIG. 4B describes the establishment of a voice over IP call from terminal 105b to terminal 105a.

With reference to FIG. 4A, terminal 105a places a phone call to terminal 105b by transmitting an INVITE signal 405 to the call server 330. The INVITE signal 405 is transmitted to the call server 330 via the firewall 120. As noted above, the INVITE signal 405 includes an identification of terminal 105a, the designation of a port number on which terminal 105a is to conduct the voice over IP call, and an identification of the called party, e.g., terminal 105b. Upon receiving the invite signal 405, the firewall 120 stores (action 410) the identification of the terminal 105a, and the designated port number.

The call server 330 receives the INVITE signal 405 and queries (signal 415) the location server 335 for the location of the called party, terminal 105b. Responsive to the query (signal 415) The location server 335 transmits the location (signal 420) to the call server 330. Upon receiving the location information (signal 420) from the location server 335, the call server 330 transmits the INVITE signal (signal 425) to the terminal 105b.

Upon receiving the INVITE signal (signal 425), the terminal 105b notifies the user, and waits for the user to accept the call. When the user accepts the call, the terminal 105b transmits an acknowledgment (ACK) signal 430 to the call server 330. The ACK signal 430 includes an identification of each terminal 105a, 105b, and a designation of a port number upon which terminal 105b is to conduct the voice over IP call. The call server 330 transmits the ACK signal 435 to the terminal 105a via the firewall 120. Upon receipt of the ACK signal 435 at the firewall 120, the firewall 120 stores the identification of the terminal 105b, and port number which terminal 105b conducts the voice over IP call, and correlates the foregoing with the identification of terminal 105a and the port number which terminal 105a conducts the voice over IP call (action 440). Upon receipt of the ACK signal 435 at terminal 105a, the voice over IP call is established between terminal 105a, and terminal 105b.

With reference now to FIG. 4B, terminal 105b establishes a voice over IP phone call with terminal 105a by transmitting an INVITE signal 455 to call server 330. Upon receipt of the INVITE signal 405, the call server 330 queries (signal 460) the location server 335 for the location information for terminal 105a. The location server 335 provides the location information to the call server 330 (signal 465). Responsive thereto, the call server 330 transmits the INVITE signal 470 to terminal 105a, via firewall 120. Upon receiving the INVITE signal 470, the firewall 120 stores (action 475) the identification of the terminals 105a and 105b, as well as the designated port number upon which terminal 105b conducts the voice over IP call. Upon receipt of the invite at terminal 105a, the terminal 105a waits until the user accepts the voice over IP call. When the user accepts the voice over IP call, the terminal 105a transmits an ACK signal 480 to terminal 105b via the firewall 120 and the call server 330. Upon receipt of the ACK signal 480 at the firewall 120, the firewall stores (action 485) the port number designated by terminal 105a and correlates the port number with the information stored from INVITE signal 470. Upon receipt of the ACK signal 480 at terminal 105b, the voice over IP call is established.

Upon establishment of the voice over IP call, where terminal 105a is either the calling terminal or the called terminal, the firewall 120 filters incoming data packets for terminal 105a. When an incoming data packet is received for terminal 105a, the firewall 120 examines the data packet for the destination address, destination port, sender address, and sender port. Wherein the foregoing fields match the information recorded during the establishment of the voice over IP call, e.g., actions 410, 440 475, 480, the data packets are permitted to reach terminal 105a. Wherein the foregoing fields do not match, the data packet is not permitted to reach the terminal 105a.

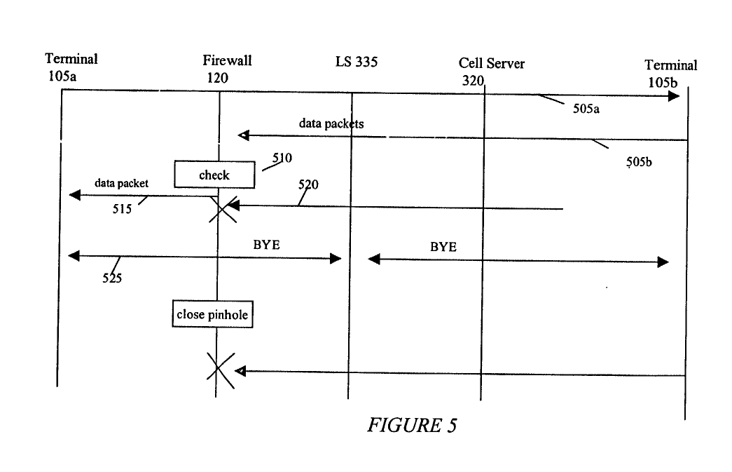

Referring now to FIG. 5, there is illustrated a signal flow diagram describing a voice over IP call. During the course of the voice over IP call, the terminals 105a, and 105b exchange data packets, signals 505a, 505b. The data packets contain digitized samplings of voice signals which are received from the user at terminals 105a, 105b and transmitted. The data packets, signals 505a, and 505b include a payload and a succession of headers. Each header includes commands and other information that is recognized by a particular protocol. The headers are organized as layers in a predetermined order known as a protocol stack. Among the layers included are layers which are known as the TCP layer and the Internet Protocol (IP) layer. The foregoing layers include the addresses and designated port numbers for each terminal 105a, 105b.

The TCP and IP layers for data packets that are received (signal 505b) at the firewall 120 for terminal 105a are examined by firewall 120 for the addresses and port number for the sending and receiving terminal. The addresses and port numbers are compared (action 510) to the addresses and port numbers stored during the establishment of the voice over IP call. Wherein the addresses and port numbers match the stored addresses and port numbers, the data packets are permitted to reach terminal 105a (signal 515). Wherein the foregoing addresses and port numbers do not match, the firewall 120 prevents the data packets (signal 520) from continuing to the terminal 105a.

The voice over IP call is terminated by transmission of a SIP BYE signal (signal 525) from either terminal to the other terminal via the call server 335. The foregoing BYE signal 525 is received at the firewall 120. Upon receiving the BYE signal 525, the firewall 120 either discards the stored calling/called terminal address/port number information or sets an indicator that the call is terminated (action 530). Thereafter, any data packets received for terminal 105b for terminal 105a are prevented from reaching terminal 105a, notwithstanding inclusion of the previously stored addresses and port numbers.

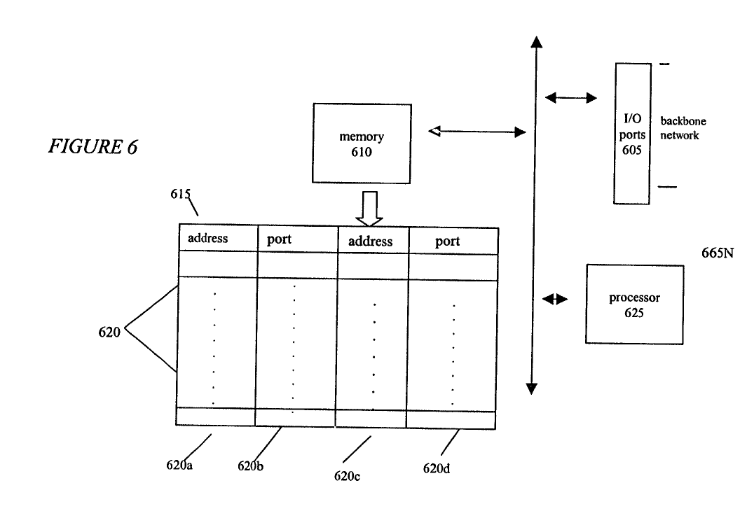

Referring now to FIG. 6, there is illustrated a block diagram of an exemplary firewall 120. The firewall includes any number of input/output (I/O) ports 605. The ports 605 facilitate connection of the firewall towards both the terminals 105a of the access network 115, and the internet 110. In one embodiment, one of the I/O ports can be used to connect the firewall to a GGSN 305 via trunk line, while another one of the I/O ports 605 can be used to connect the firewall to a backbone network 325 via another trunk line. The trunk line, can include, for example, a T1, E1 or an Ethernet connection, to name a few. Connection of the firewall 120 towards the terminal 105a, and the internet 110 permits receipt of all data packets transmitted to and from terminal 105a. Accordingly, the firewall 120 can receive and transmit the SIP INVITE, ACK, and BYE signals. Additionally, the firewall 120 can receive and transmit each of the data packets which are addressed to terminal 105a.

The firewall 120 also includes memory 610 for storage of a voice over IP call table 615. The voice over IP call table 615 includes any number of records 620, each of which is associated with a particular terminal 105a engaged in a voice over IP call. Each record contains a first terminal identifier 620a, a first port number identifier 620b, a second terminal identifier 620c, and a second port number identifier 620d.

The first terminal identifier 620a identifies the terminal, e.g., terminal 105a, associated with the record 620. The first port number identifier 620b identifies the port number upon which the terminal 105a associated with the record is conducting the voice over IP call. The second terminal identifier 620c identifies the terminal, e.g., terminal 105b, with which the terminal 105a associated with the record is engaging in a voice over IP call with. The second port number identifier 620d identifies the port number upon which the terminal identified by 620c is conducting the voice over IP call.

The memory 610 can also store a plurality of instructions executable by a processor 625. The foregoing instructions when executed by the processor 625 cause the processor 625 to create and initialize a record 620, responsive to receipt of an SIP INVITE signal, e.g, signals 405, 470. Wherein the SIP INVITE signal is received from a terminal 105a of access unit 115, e.g., signal 405, the calling party address, and calling party port number are stored at the first terminal identifier 620a and first port number identifier 620b, respectively. When the corresponding ACK signal is received from terminal 105b, the identifier of terminal 105b and the port number used by terminal 105b for the voice over IP call are stored in second terminal identifier 620c and second port number identifier 620d.

Wherein the SIP INVITE signal is received from a terminal 105b requesting a voice over IP call to a terminal 105a of the access network 115, e.g., signal 470, the identifier of the terminal 105b sending the request and the identifier of the port number for terminal 105b are stored at second terminal identifier 620c and second port number identifier 620d. The address of the called terminal 105a is stored at first terminal identifier 620a. During the corresponding ACK, signal 480, the port number designated for the voice over IP call for terminal 105a is stored at first port number identifier 620b.

When data packets are received for a terminal 105a of access network 115, the table 615 is searched for a record 620 with a first terminal identifier 620a identifying terminal 105a. Wherein such a record 620 is found, the identifiers 620b, 620c, and 620d are compared with the information contained in the data packet. Wherein the foregoing information matches, the data packet is permitted to reach terminal 105a. If the foregoing information does not match, the data packet is prevented from reaching the terminal 105a.

Additionally, upon receipt of a BYE signal terminating a voice over IP call between a terminal 105a in the access network 115 and another terminal 105b, the record 620 associated with terminal 105a is deleted or otherwise invalidated from the table 615. Thereafter, additional data packets transmitted from terminal 105b to terminal 105a containing the previously stored port numbers are prevented from reaching terminal 105a.

Although the foregoing detailed description describes certain embodiments with a degree of specificity, it should be noted that the foregoing embodiments are by way of example, and are subject to modifications, substitutions, or alterations without departing from the spirit or scope of the invention. For example, one embodiment can be implemented as sets of instructions resident in memory 610. Those skilled in the art will recognize that physical storage of instructions physically changes the medium upon which it is stored electronically, magnetically, and/or chemically so that the medium carries computer readable information. Additionally, another embodiment can be implemented as part of a wireless content switch, such as the wireless content switch described in U.S. patent application Ser. No., 09/718,713 entitled “System and Method for Wireless Content Switch”, filed Nov. 22, 2000, by Jogen Pathak and others, which is hereby incorporated by reference for all purposes. Accordingly, the invention is only limited by the following claims, and equivalents, thereof.

What is claimed is:

1. A method for securing a communication session over a packet data network, said method comprising:
receiving a signal including a port number associated with a first terminal;
receiving data packets from a second terminal for transmission to the first terminal; and
transmitting the data packets to the first terminal, wherein the data packets identify the port number associated with the first terminal.

2. The method of claim 1, wherein receiving the signal including a port associated with the first mobile station further comprises:
receiving communication setup signals including the port number associated with the first terminal.

3. The method of claim 2, wherein receiving the call setup signals further comprises:
receiving a Session Initiation Protocol Invite signal.

4. The method of claim 1, further comprising:
determining the port number identified by the data packets.

5. The method of claim 4, wherein determining the port number identified by the data packets further comprises:
examining a layer of a protocol stack associated with the data packets.

6. The method of claim 1, further comprising:
discarding the data packets, wherein the data packets do not identify the port associated with the first terminal.

7. The method of claim 1, further comprising:
receiving a termination signal for the communication session;
receiving data packets identifying the port number associated with the first terminal after receiving the termination signal; and
discarding data packets received after receiving the termination signal.

8. The method of claim 1, wherein the data packets comprise digitized voice signals.

9. The method of claim 1, wherein the first terminal comprises a mobile station.

10. A firewall for securing a data session, said wireless content switch comprising:
a plurality of input/output ports for:
receiving signals including port numbers associated with a first plurality of terminals;
receiving data packets from a second plurality of terminals for transmission to the first plurality of terminals; and
transmitting the data packets to the first plurality of terminals, wherein the data packets identify the port numbers associated with the first plurality of terminals;
a memory for storing a plurality of records, each of said records associated with a particular one of the first plurality of terminals, wherein each record comprises:
a first terminal identifier for identifying the particular one of the first plurality of terminals associated with the record; and
a first port number identifier for identifying the port associated with the terminal associated with the record.

11. The firewall of claim 9, further comprising:
a processor for executing a plurality of instructions; and
wherein the memory stores the plurality of executable instructions, said plurality of executable instructions comprising:
comparing the port numbers identified in the data packets for the first plurality of terminals with the port numbers identified by the first port number identifiers of records associated with the first plurality of terminals.

12. The firewall of claim 11, wherein the instructions for comparing further comprise instructions for examining a layer of a protocol stack.

13. A computer readable medium for storing a plurality of executable instructions, said plurality of instructions comprising:
storing a port number associated with a first terminal, responsive to receiving a first signal for establishing a data transfer session between the first terminal and a second terminal;
comparing a port number identified in data packets for the first terminal, responsive to receiving the data packets; and
transmitting the data packets to the first terminal, wherein the data packets identify the stored port number.

14. The computer readable medium of claim 13, wherein the plurality of instructions further comprise:
storing an address associated with a second terminal, responsive to receiving a second signal for establishing the data transfer session.

15. The computer readable medium of claim 14, wherein the plurality of instructions further comprise:
comparing an address identified in the data packets with the address associated with the second terminal.

16. The computer readable medium of claim 13, wherein the first terminal comprises a mobile station.
